(19) United States
(12) Patent Application Publication
(10) Pub. No.: US 2007/0175529 A1
(43) Pub. Date: Aug. 2, 2007

(54) Three-way, two-position in-tube solenoid gas valve assembly

(76) Inventors: Wei-Ching Wang, Mississauga (CA); Chia-ping Wang, Mississauga (CA); Yu-ching Wang, Mississauga (CA)

Correspondence Address: Wei-Ching Wang, 1791 Branchwood Park, Mississauga, ON, L4W 2E5, CA

(21) Appl. No.: 11/344,488

(22) Filed: Feb. 1, 2006

(51) Int. Cl. F16K 31/06

(52) U.S. Cl. 137/625.65

(57) ABSTRACT

A new three-way, two-position in-tube solenoid gas valve assembly comprises a modified in-tube solenoid gas valve and a pair of gas release valves is designed to control pneumatic systems. The modified in-tube solenoid gas valve is a modification based on the previous invention by Wang et al., U.S. Ser. No. 10/924,789. The new modifications are first adding a rod-piston assembly onto the solenoid assembly, a new inlet was added to the valve tube and two outlet fittings were also added. With these modifications, the systems can now work with two directions of gas flows, which is important to control pneumatic systems. To be able to control pneumatic systems properly, two gas release valves are included as part of the assembly. The goal of these two gas release valves is to be able to release gas from pneumatic quickly and completely. These gas release valves are operated based on two compression springs and through gas inputs into the valves. The operations of the gas releases valves are simultaneously while one opens the other closes. The opening and the closing of the gas release valve depends on the state of the modified solenoid gas valve.

### FIELD OF THE INVENTION

The primary application field of the invention relates to a solenoid valve and more particularly, to a three-way, two-position in-tube solenoid gas valve assembly to switch the gas passage in high pressure pneumatic system.

### BACKGROUND OF THE INVENTION

Comparing to hydraulics, pneumatics systems often have many disadvantages in different fields of applications in the present market. For example, the typical pressure range of hydraulic system is from 500 to 5,000 psig while a typical pneumatic system, the common pressure range from 0 to 80 psig, sometimes up to 1,000 psig for some special applications. However, there are reasons people would prefer a pneumatic system to a hydraulic one because of the simplicity of a pneumatic system which provides a low cost. I addition, it can be easily adapted to current applications and it is less sensitive to environmental factors. Since the hydraulic power system requires more complex conversion equipment which is not suitable for the portable or movable applications; hence, the demand of high pressure gas in pneumatic system is increasing. High pressure pneumatics can reach a higher stiffness than that of less pressure so that it provides a much stronger support than the low pressure system. The three-way solenoid valve of prior arts, U.S. Pat. No. 5,135,027 and 5,618,087, has been disclosed. In those inventions, the piston or ball is directly driven by a solenoid device that is actuated by an electrical signal to enable the system. However, those solenoid valves are not applicable in high pressure pneumatic system. There are also many poppet and spool type solenoid valves in the market. For example, in the prior art, U.S. Pat. No. 5,996,629, it has a movable spool (a valve body) which is driven by solenoid devices in a cylindrical chamber (a valve hole), communicating with several intersect channels, to switch the route of fluid passage. The gap distance between the spool and the chamber is very crucial. Normally, the surface of the pool has to be very smooth so that the gap distance can be controlled. The chamber and channels in a manifold are made by milling and subsequent finishing procedures. However, burrs are generated during machining procedure; hence, to clean all foreign material as well as burrs before assembling the valve is mandatory. Due to the inefficiency of the manual operation processes of cleaning and de-burring, the quality control of production of valve is dismal. In this invention, an innovate design, described hereafter, based on the prior art, U.S. patent application Ser. No. 10/924,789, in-tube solenoid gas valve, is a three-way, two-position solenoid valve assembly. This assembly consists of a modified in-tube solenoid gas valve and two additional gas release valves to reach a fast and reliable operation. In this design, a solenoid gas valve is used to control the direction of the flow while the movement of the pneumatic system is controlled by the pressure difference exerted by the high pressure gas.

### SUMMARY OF THE INVENTION

Accordingly, it is an object of the present invention to provide a three-way, two-position in-tube solenoid gas valve assembly of the above mentioned general type which avoids the disadvantages of the prior arts.

It is also an object of the present invention to provide a three-way, two-position in-tube solenoid gas valve assembly that can be used for high pressure pneumatic system.

It is also an object of the present invention to provide a three-way, two-position in-tube solenoid gas valve assembly that will virtually act instantaneously.

It is also an object of the present invention to provide a three-way, two-position in-tube solenoid gas valve assembly that will save the manufacturing costs.

A three-way, two-position in-tube solenoid gas valve assembly according to the invention has an inlet in the valve tube located in the radial direction of a modified in-tube solenoid gas valve and two outlets at each end of the modified in-tube solenoid gas valve. An extend piston molded with plastic insert is connected to a solenoid assembly with a rod. The gas flow through one of the outlet to one side of a pneumatic system when the solenoid is not energized. When solenoid is energized, the solenoid assembly is moved by gas pressure differential force, to let gas flow to the other side of the pneumatic system at the meantime, the extend piston, pushed by the solenoid assembly, closes one of the outlet. There are two gas release valves that are used for releasing gas in the pneumatic system. When the supply gas flows to the acting side of the pneumatic system, the gas in the other side of the pneumatic system is pushed out by the piston and is released by one of the gas release valves.

The modified in-tube solenoid gas valve, as described in the prior art, U.S. patent application Ser. No. 10/924,789, having the characteristic function that open and close valve instantaneously, acts as the main component of this three-way, two-position in-tube solenoid gas valve assembly. The modified in-tube solenoid gas valve controls the flow direction of the gas into the pneumatic system.

A gas release valve comprises of a body piston and a cap piston, which are actuated by gas pressure from the outlets of the modified in-tube solenoid gas valve. The gas release valve helps the residue gas in the pneumatic system to escape.

The novel features which are considered as characteristics for the present invention are set forth in particular in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWINGS

FIG. 1 is a schematic diagram of a pneumatic system with a three-way, two-position in-tube solenoid gas valve assembly.

FIG. 2 is a cross-sectional view of a modified in-tube solenoid gas valve.

FIG. 3 is a cross-sectional view of a gas release valve.

FIG. 4 is a connection diagram of modified in-tube solenoid gas valve and two gas release valves in the state of no gas is in valves.

FIG. 5 is a connection diagram of modified in-tube solenoid gas valve and two gas release valves in the state that the gas starts to input into valves and the solenoid is de-energized.

FIG. 6 is a connection diagram of modified in-tube solenoid gas valve and two gas release valves in the state that the gas is in valves and the solenoid is energized.

FIG. 7 is a connection diagram of modified in-tube solenoid gas valve and two gas release valves in the state that the gas is in valves and the solenoid is de-energized again.

### DESCRIPTION OF PREFERRED EMBODIMENT

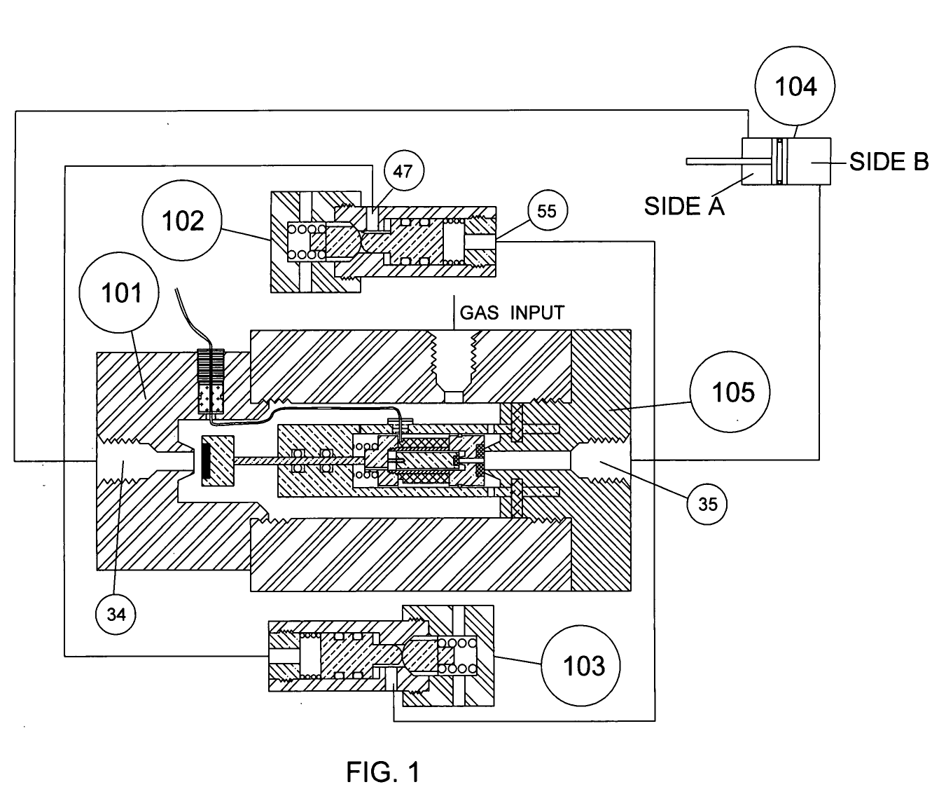

Attention is first directed to FIG. 1, which shows a schematic diagram of a pneumatic system 104 having sides A and B is attached to a three-way, two-position, in-tube solenoid valve assembly, which consists of a modified in-tube solenoid gas valve 101 and two identical gas release valves 102 and 103. Side A of cylinder 104 is connected to exiting port 34 of the modified in-tube solenoid gas valve 101, port 47 of gas release valve 102 and port 55 of gas release valve 103. Side B of cylinder 104 is connected to the existing port 35 of the modified in-tube solenoid gas valve 101, port 55 of gas release valve 102 and port 47 of gas release valve 103.

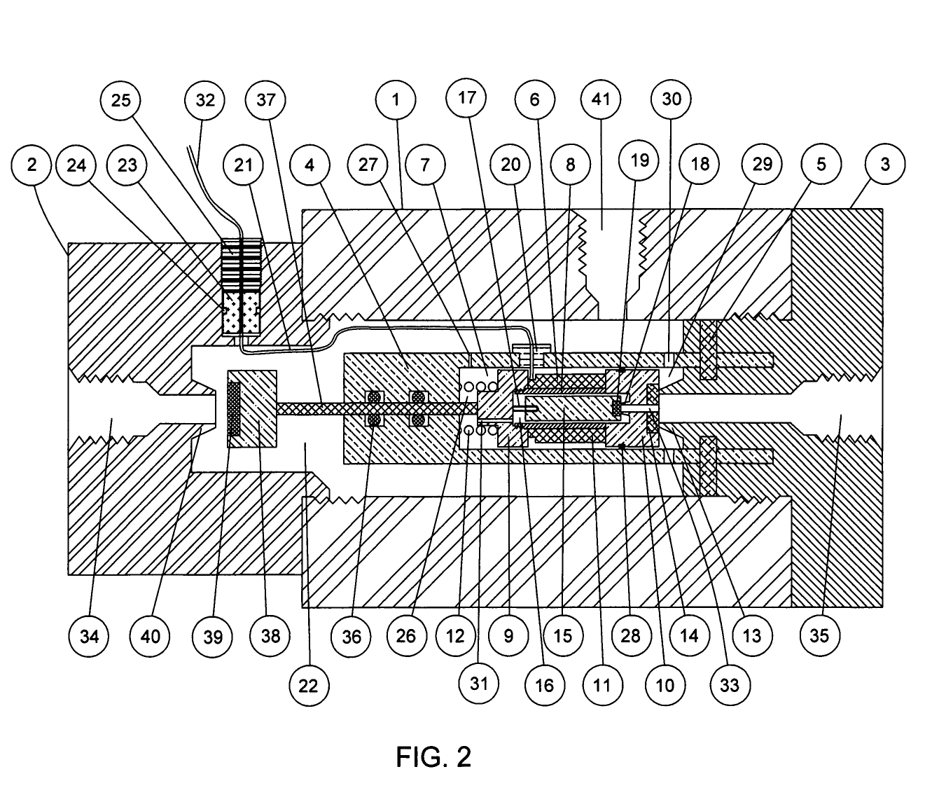

FIG. 2 shows a section view of a modified in-tube solenoid gas valve. The valve tube 1 has a hollow hole with internal thread at both ends to accept both outlet fittings 2 and 3. Both fittings have an exiting port 34 and 35 with internal threads for connecting adaptive fittings of piping system. A gas input port 41 is located at a side of the valve tube 1 of the modified in-tube solenoid gas valve 101. Cavity 22 is formed by the valve body 1, the two outlet fittings 2 and 3.

A cylindrical body 4 having only one chamber 26 provides a space for the movement of a solenoid assembly 6 that comprises a hollow sleeve 8, a stop 9, flange 10 and an electrical coil 11. The opening end of the cylindrical body 4 is connected to the outlet fitting 3 with pins 5. A rod 37 with extend piston 38, connects the movable solenoid assembly 6, and is supported by the cylindrical body 4. A pair of o-ring 36 blocks the gas communication between chamber 26 and cavity 22. A plastic insert 39 is molded on extend piston 38 to provide seal.

A compression spring 12 pushes the solenoid assembly 6 to a seal seat 13 of the outlet fitting 3 at the initial state. A plastic insert 14 is molded onto the flange 10 to provide seal. A magnetic rod 15 moveable axially in chamber 16 of the hollow space of hollow sleeve 8, while a compression spring 17 pushes magnetic rod 15 against a small seal seat 18 of the flange 10 at the initial state. A rubber insert 19 is molded onto magnetic rod 15 to provide seal.

An internal pass-through plug 20, inserting into support cylindrical body 4, provides the strain relief of lead wires of coil 21 which extends from electrical coil 11, through the support cylindrical body 4, to the cavity 22 of the valve tube 1. The lead wires of coil 21 are soldered onto the terminals of an external pass-through connector 23 at the bottom of connector 23. The external pass-through connector 23 is placed in the outlet fitting 2 with an o-ring 24 that seals high pressure gas. Because of the high pressure in the valve tube 1, a metal plug 25 with a centre hole is threaded into the outlet fitting to hold the external pass-through connector 23.

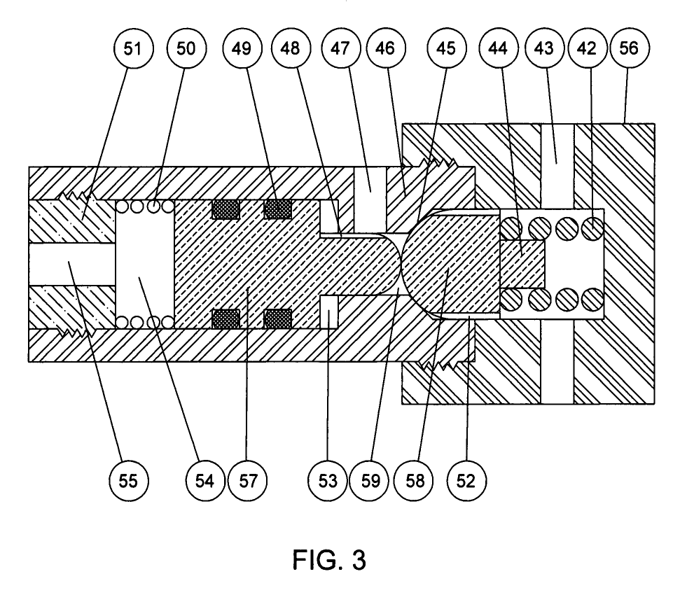

FIG. 3 displays a section view of a gas release valve which consists of a cap 56 with a body 46, where the body 46 is threaded into the cap 56. Cap 56 consists of a compression spring 42 and a cap piston 58 which movable within chamber 52 of the cap 56. Cap 56 has through ports 43 to provide a gas outlet to the atmosphere. Body 46 consists of a body piston 57, a compression spring 50 and an inlet fitting 51. Body piston 57 is movable within chamber 54. A pair of o-ring 49 prevents the communication of gas between chambers 53 and 54. A port 47 is located at the side of the body 46 to provide a gas inlet. The inlet fitting 51 having a port 55 to provide gas inlet is threaded into body 46. A gas communication groove 48 connects port 47 and front body piston chamber 53.

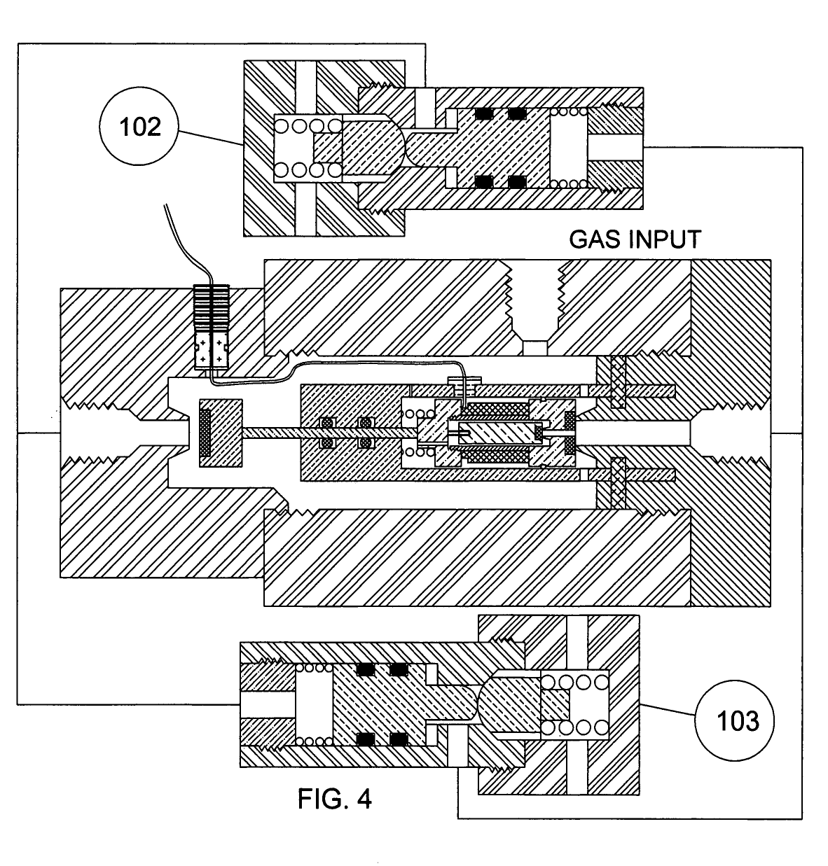

FIG. 4 displays the entire assembly configuration that the pneumatic system is not being used. It also shows the initial state of the assembly. Initially, the solenoid is inactive and there is no gas flow into the modified solenoid gas valve 101.

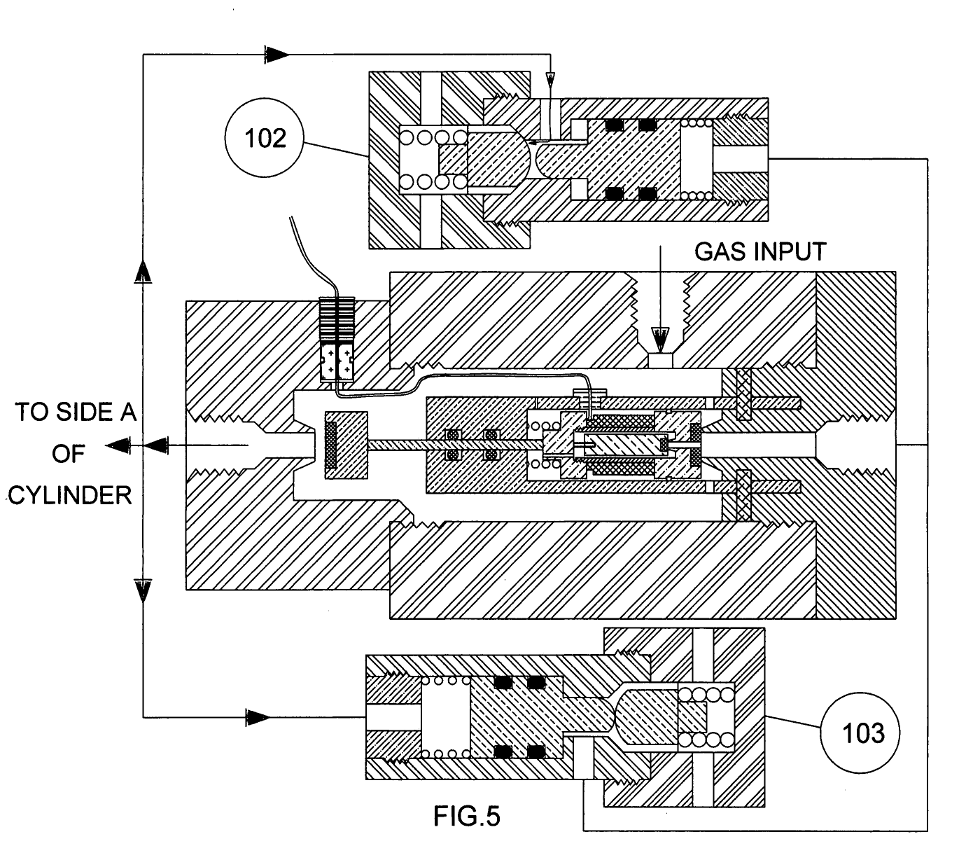

FIG. 5 shows when the gas is allowed to flow into the modified solenoid gas valve 101. Initially, the compression spring 17 pushes the magnetic rod 15 to seal bleed orifice 33 to port 35 and compression spring 12 pushes solenoid assembly 6 to stop gas flows to port 35. Gas flows through the input port 41 of the modified in-tube solenoid gas valve 101 via cavity 22 and exiting through port 34. The exiting gas enters port 47 of gas release valve 102, port 55 of gas release valve 103 and side A of cylinder 104 simultaneously. In the pressure release gas valve 103, the gas enters chamber 54 via port 55 and builds up the pressure in chamber 54. The sum of forces of gas pressure in chamber 54 and compression spring 50 is greater that of compression spring 42. Body piston 57 pushes cap piston 58 to open for gas to exit. In gas release valve 102, gas from input port 41 flows to chambers 53 and 59 via port 47 and port 34. The force exerted by gas pressure in chambers 53 and 59 is greater than that of compression spring, so that, compression spring 50 is compressed and body piston 57 is separated from cap piston 58. However, because the force excreted by gas pressure in chambers 53 and 59 is less than that of compression spring 42, cap piston 58 remains closed, preventing gas from escaping. In pneumatic system 104, the exiting gas from modified in-tube solenoid gas valve 101 flows into side A of the system pushes the piston towards side B. The residue gas initially in side B of cylinder 104 is being “squeezed” out and enters the gas release valve 103 via port 47. Because valve is open, the exiting gas from side B of cylinder 104 can escape through chamber 52 and port 43 to the atmosphere. At this stage, while the solenoid remains inactive, the gas filled up the chambers 26, 16 and 29 via pass-through holes 27, 31 and 30. Because the pressure between chamber 26 and chamber 29 is equal, with the action of the compression spring 12, the modified in-tube solenoid gas valve remains closed.

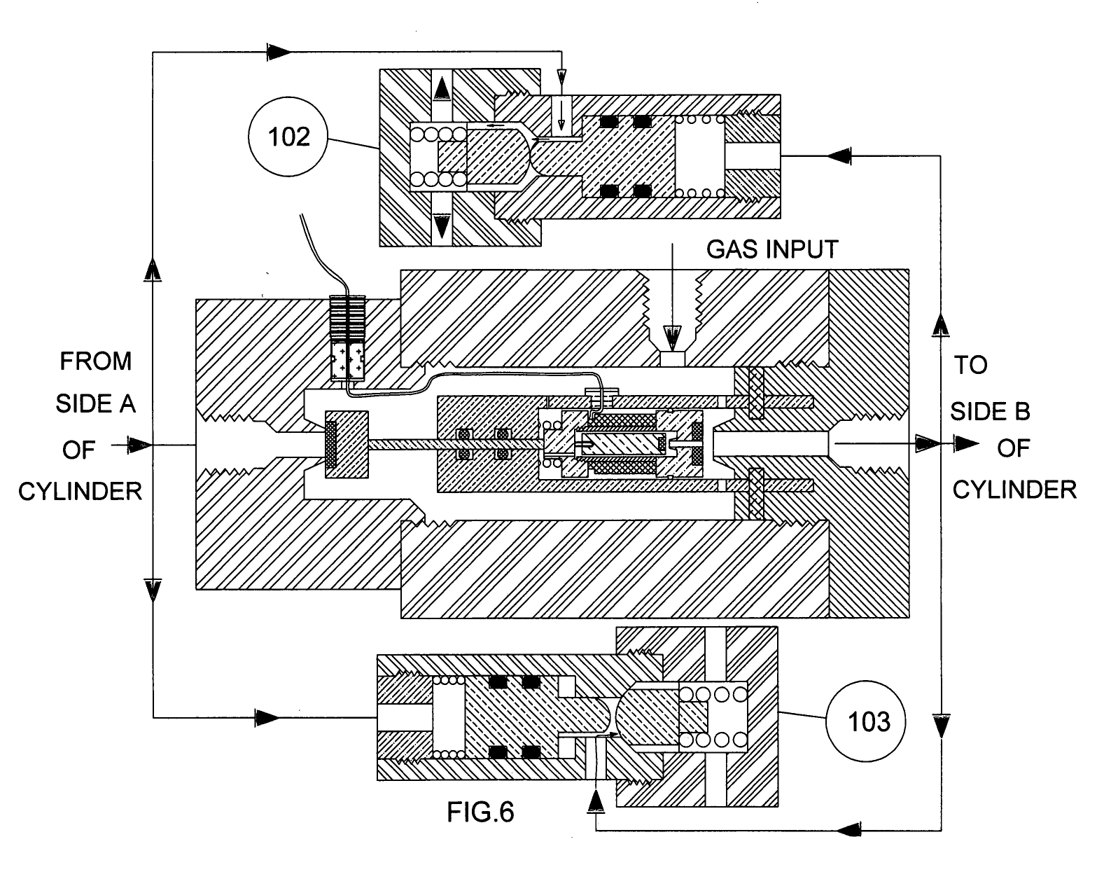

When the solenoid in the modified in-tube solenoid gas valve 101 is active, as shown in FIG. 6, the bleed orifice 33 opens to allow gas in chambers 26 and 16 to flow to the port 35, reduces the pressure in chamber 26. Because the pressure in chamber 29 is greater than that of chamber 26, the valve opens. (For detailed operation, please refer to U.S. Ser. No. 10/924,789). Due to the movement of the solenoid assembly 6 in the modified in-tube solenoid gas valve 101, piston 38 closes port 34 and opens port 35. When port 35 is open, incoming gas through port 41 enters cavity 22 and exits at port 35 via through-hole 30. The exiting gas enters the port 55 of gas release valve 102, port 47 of gas release valve 103 and side B of cylinder 104 simultaneously. In gas release valve 102, the exiting gas from the modified in-tube solenoid gas valve 101 enters chamber 54 via port 55 and builds up the pressure in chamber 54. Because the sum of the force created by gas pressure in chamber 54 and the force exerted by the compression spring 50 is larger than the force exerted by the compression spring 42 and by gas pressure in chamber 53, piston 57 pushes piston 58 to move and opens valve. The gas in side A of cylinder 104 is released to atmosphere. Because chambers 54 and 53 are not communicating, the exiting gas from the modified in-tube solenoid gas valve remains in chamber 54. The exiting gas enters chamber 59 of the pressure release valve 103 via port 47. Because the force excreted by pressure in the chamber 53 and 59 is less than that of by the compression spring 42, piston 58 remains unmoved. In cylinder 104, the exiting gas from the modified in-tube solenoid gas valve enters the side B of the pneumatic system 104 causes the piston to move towards side A of the system. The gas that was in the side A of the system is being “squeezed” out into both pressure release valve 102 and 103. Because the only pressure release valve 102 is open at the moment, the gas in side A of cylinder 104 vents out through port 47 and outlet 43.

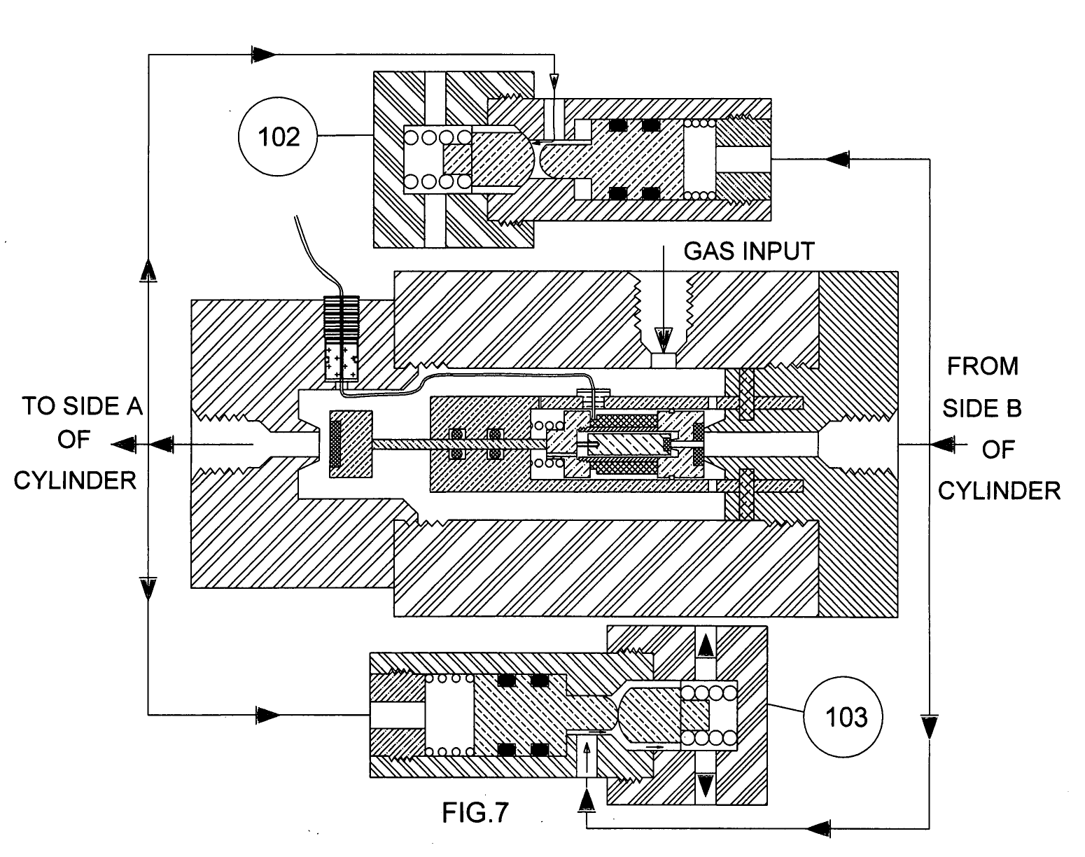

When the solenoid is turned off, as shown in FIG. 7, the magnetic rod 15 moves back to block the bleed orifice 33. As the gas fills the chambers 26 and 16, the gas pressure between chamber 26 and chamber 29 is equalized, and by the act of compression spring 12, the solenoid assembly 6 moves back to close port 35. At the same time, it opens port 34. Gas flows through port 41 and exiting through port 34 via cavity 22 into port 47 of gas release valve 102, port 55 of gas release valve 103 and side B of cylinder 104. In gas release valve 103, the gas enters chamber 54 via the inlet 55. The pressure build up in chamber 54 pushes the piston 57 which in turn pushes piston 58. As a result of the movement of piston 58, the valve is opened. The gas in the side A of cylinder 104 is released to atmosphere. In gas release valve 102, gas enters chambers 59 and 53 via groove 48. Since the force excreted by gas in the chambers 53 and 59 is greater than that by compression spring 50, piston 57 is separated from piston 58. Because the force exerted by the compression spring 42 is large enough to overcome the pressure build up in chambers 53 and 59, piston 58 remains unmoved. No gas is escaping through gas release valve 102. However, because chambers 54 and 59 are not communication, exiting gas from port 34 of the modified in-tube solenoid gas valve 101 remains in the chamber 54. The exiting gas from the modified in-tube solenoid gas valve 110 enters the side A of cylinder 104 which pushes the piston towards side B of the system. The gas that was in the side B of the system is then being “squeezed” out to the two gas release valves 102 and 103 and the port 35 of the modified in-tube solenoid gas valve 101. Because the port 35 of the modified in-tube solenoid gas valve 101 is closed, the gas from side B of cylinder 104 can only flow to gas release valves 102 and 103. However, since only gas release valve 103 has a route for venting the gas, via passage way 48 and port 43, all gas eventually will exit through this route.

What is claimed is:

1. A three-way, two-position in-tube solenoid gas valve assembly for controlling a pneumatic system by means of high pressure gas comprising: a modified in-tube solenoid gas valve and two gas release valves, namely, a gas release valve 102 and a gas release valve 103.

2. The modified in-tube solenoid gas valve as defined in claim 1 comprising: (1) a valve tube defining a gas inlet passage, two gas outlet passages and a cavity; (2) said gas inlet passage with internal thread locates at the side of said valve tube; (3) two outlet fittings, namely, a normally open outlet fitting and a normally close outlet fitting with an axial hole, threading into said outlet passages of said valve tube providing gas exit ports of said modified in-tube solenoid gas valve to connect to piping system and said outlet fittings providing seal seat to seal gas in said modified in-tube solenoid gas valve; (4) a support cylindrical body with a chamber inserting into said normally close outlet fitting by pins; (5) a solenoid assembly comprising a flange, an electrical coil, a stop, and a sleeve, able to slide in said chamber of said support cylindrical body; (6) said solenoid assembly comprising an o-ring located in said flange for segregating said chamber of said support cylindrical body to a front side chamber and a back side chamber; (7) said flange provides a orifice seal seat, a bleed orifice, and an axial hole; (8) a plastic insert with a center hole, is molded onto said flange, to provide seal; (9) a rod-piston assembly is attached to said stop of said solenoid assembly; (10) said rod-piston assembly consisting of a rod and a piston; (11) a plastic insert is molded onto said piston of said rod-piston assembly to provide seal; (12) said piston passes through a center hole of said support cylindrical body, so that, the assembly of said rod-piston and said solenoid assembly opens or closes said gas exit ports of said modified in-tube gas valve; (13) a pair of o-ring locating at circumference of said rod prevent gas communication between said cavity and said front side chamber; (14) a magnetic rod is able to slide within hollow space of said sleeve of said solenoid assembly; (15) a rubber insert is molded onto said magnetic rod to provide seal; (16) extend lead wires of said electrical coil pass through the hole of an internal pass-through plug which is inserted into said support cylindrical body and is used for the purpose of strain relief; (17) said extend lead wires of said electrical coil, is soldered on terminals of an external pass-through connector at one end; external wires, from a power supply and through a threaded metal plug with a center hole, is soldered on terminals of said external pass-through connector at the other end; electrical current pass through said external wires from a power supply, said external pass-through connector, to said lead wires of said electrical coil, to provide a magnetic field for movement of said magnetic rod and said solenoid assembly; (18) said external pass-through connector comprising an o-ring for sealing internal pressure gas in said cavity of said valve tube; said thread metal plug is threaded into one of said outlet fitting to hold said external pass-through connector in one of said outlet fitting; (19) a compression spring pushes said solenoid assembly, so that, said flange against said seal seat of said normally close outlet fitting; (20) a compression spring pushes said magnetic rod against said orifice seal seat of said flange.

3. The gas release valve as defined in claim 1 comprising: a cap assembly, a body assembly; said cap assembly connects said body assembly with thread; said cap assembly comprising a cap, a compression spring, and a cap piston; said cap having a chamber to provide a central room opening at one end with internal threads for placing said compression spring and said cap piston and connecting with said body assembly; the tip of said cap piston has a conical concave shape to act as seal seat; said cap having through ports connecting to said central room to provide gas releasing exit to atmosphere; said body assembly comprising a body, an inlet fitting, a compression spring and a body piston; said body having two connected central coaxial longitudinal cylindrical hollow spaces with different diameters which are open at both ends, namely, a gas actuated room and a gas release room; an interference wall is created between said gas actuated room and said gas release room due to the difference in diameter; a gas release port locates at the circumference of said body for gas to flow between said gas release room and the modified in-tube gas solenoid valve; said body piston having two cylindrical parts, namely, an actuated cylindrical part and a release cylindrical part, sitting and slide able within said gas actuated room and said gas release room of said body; said release cylindrical part has a conical concave shape to act as seal seat; a commute groove located circumferentially of said release cylindrical part longitudinally to commute gas between said gas actuated room and said gas release room; a pair of o-ring located circumferentially of said actuated cylindrical part to segregate said gas actuated room to a front body piston chamber and a back body piston chamber; said pair of o-ring block gas communicate between said front body piston chamber and said back body piston chamber; said inlet fitting of said body assembly threads into said back body piston chamber; a through hole in said inlet fitting to provide actuated gas from said modified in-tube solenoid gas valve; said compression spring of said body assembly locating against said inlet fitting of said body assembly and said actuated cylindrical part of said body piston to push said body piston against one end of front body piston chamber which connects to said gas release room; when said cap piston being pushed by said compression spring of said cap assembly onto said central concave conical seal seat of said body of said body assembly.

4. A three-way, two-position, in-tube solenoid gas valve assembly as defined in claim 1 for controlling a pneumatic system by means of high pressure gas; said normally open outlet fitting connects to one side of a pneumatic cylinder, namely side A; also said normally open outlet fitting connects to said inlet fitting of said body assembly of said a gas release valve 103; also, said normally open outlet fitting connects to said gas release port of said body assembly of said a gas release valve 102; said normally close outlet fitting connects to one side of a pneumatic cylinder, namely side B; also said normally close outlet fitting connects to said inlet fitting of said body assembly of said a gas release valve 102; also said normally close outlet fitting connects to said gas release port of said body assembly of said a gas release valve 103.

5. Such that a method of enabling the operation of said modified in-tube solenoid gas valve defined as in claim 2 comprising the steps: (a) providing gases from said gas input port and exiting said gas exit port of said normally open outlet fitting; normally said rod-piston assembly is in the open position; (b) when the solenoid is activated, said solenoid assembly moves to open said gas exit port of said normally close outlet fitting and, so that the gas is allowed to exit through said gas exit port of said normally close outlet fitting; at the same time, moves said rod-piston assembly into closed position, so that the rod-piston assembly closes the outlet and block the exit of gas through said gas exit port of said normally open outlet fitting; (c) when the solenoid is de-activated, the solenoid assembly closes said gas exit port of said normally close outlet fitting with said compression springs (as defined in claim 1, (19), (20)); while move said rod-piston assembly to an open position to allow the gas exit said gas exit port of said normally open outlet fitting.

6. Such that a method of enabling operation of said gas release valve 102 and said gas release valve 103 defined as in claim 1, function with said modified in-tube solenoid gas valve, comprising the steps: (a) exiting gas through said gas exit port of said normally open outlet fitting enters gas inlet port of said body of gas release valve 102 and said inlet fitting of said body assembly of said gas release valve 103 simultaneously; in said gas release valve 102, the gas fills said front body piston chamber of said body, pushes said body piston of said body assembly and said cap piston of said cap assembly back; because the force exerted by said compression spring of said cap assembly is stronger than the force exerted by the high pressure gas, said cap piston remains unmoved. Hence, gas is trapped in said front body piston chamber, at the same time, said body piston is being pushed back, separating from said cap piston; in said gas release valve 103, the gas fills up said back body piston chamber, pushes said body piston of said body against the wall between said gas actuated room and said gas release room of said body and pushes said cap piston back to open a space to allow the gas that was initially in said side B of said pneumatic cylinder that is being “squeezed” out to escape; (b) when the solenoid is activated, exiting gas through said gas exit port of said normally close outlet fitting solenoid assembly enters gas release port of said body of said gas release valve 103 and said inlet fitting of said body assembly of said gas release valve 102 simultaneously. In said gas release valve 102, the gas fills said back body piston chamber, pushes said body piston against the wall between said gas actuated room and said gas release room of said body and pushes said cap piston back to create a pathway to allow the gas from said side A of said pneumatic cylinder to escape. In said gas release valve 103, the gas enters gas release port of said body and fills said front body piston chamber and pushes said body piston back. Since the force exerted by said compression spring of said cap assembly is stronger than the gas pressure, said cap piston moves back to the original position against said central concave conical seal seat of said body to close off the pathway. The gas stays in said front body piston chamber. (c) when the solenoid is not activated again, being helped by said compression springs (as defined in claim 1, (19) and (20)), both said magnetic rod and said solenoid assembly close said gas exit port of said normally close outlet fitting and at the same time, said gas exit port of said normally open outlet fitting is open. In such way, the action of energize or de-energize the solenoid can switch the gas passage to change the direction of the movement of said cylinder in a pneumatic system.
